(19) United States
(12) Patent Application Publication
(10) Pub. No.: US 2026/0019340 A1
(43) Pub. Date: Jan. 15, 2026

(54) SYSTEM AND METHOD FOR ANALYZING NETWORK PERFORMANCE BASED ON LOCATION

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Kanjurmarg West, Mumbia (IN); Haresh B. AMBALIYA, Bhundani, Gujarat (IN); Makarand Sushil DERE, Panvel, Maharashtra (IN); Aishwary JAIN, Madhya Pradesh (IN); Vikram SINGH, Navi Mumbai (IN)

(73) Assignee: JIO PLATFORMS LIMITED, Ahmedabad, Gujarat (IN)

(21) Appl. No.: 18/992,704

(22) PCT Filed: May 20, 2024
(86) PCT No.: PCT/IN2024/050588

§ 371 Date: Jan. 9, 2025

(30) Foreign Application Priority Data
Jun. 28, 2023 (IN) 202321043267

(51) Int. Cl. H04L 41/142; H04L 41/12; H04W 4/021; H04W 24/02

(52) U.S. Cl. CPC H04L 41/142; H04L 41/12; H04W 4/021; H04W 24/02

(57) ABSTRACT

The present disclosure provides a system (108) and a method (300) for analysing network performance based on location. The system utilizes precise latitude and longitude coordinates, the system provides accurate insights into performance of specific areas, enabling operators to identify and address area-specific network issues effectively. The system allows for proactive issue identification, helping operators prevent customer dissatisfaction and enhance overall network performance by identifying network issues such as barring, coverage, outage, congestion, and interference, enabling operators to optimize the network in those areas and improve customer satisfaction. Additionally, the system provides valuable information to customer care agents, allowing them to assist customers accurately regarding network issues and resolutions. Further, by plotting the best serving plot(s) at analysed locations and considering various aspects of network performance, operators gain a comprehensive understanding of network's strengths and weaknesses, facilitating targeted improvements.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for network performance analysis in a wireless telecommunications network. More particularly, the present disclosure relates to a system and a method for analysing network performance analysis of geographical locations.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In today's interconnected world, reliable network performance plays a vital role in delivering seamless communication services. Network operators continually strive to provide optimal connectivity and address any issues that may arise. However, efficiently identifying and resolving network problems can be a challenging task, especially in large-scale networks that span diverse geographic areas.

Traditionally, network analysis has been based on aggregate data or generalized performance metrics, offering limited insights into specific locations. This approach often fails to capture area-specific issues that can significantly impact network performance and customer satisfaction. These traditional methods may not efficiently identify network issues before they escalate, resulting in delayed resolutions and increased customer dissatisfaction. Without location-specific analysis, operators may miss early signs of problems, hindering their ability to address issues promptly.

Furthermore, these traditional methods may not provide customer care agents with sufficient information when assisting customers with network-related issues. Agents may lack specific insights into the performance of a customer's location, making it challenging to provide accurate and timely support. This limitation can lead to prolonged resolution times and frustration for customers seeking assistance.

Additionally, without precise location-based analysis, traditional methods often struggle to allocate resources effectively for network optimization. Operators may lack a clear understanding of which areas require the most attention, leading to inefficient utilization of resources. This inefficient resource allocation can result in suboptimal network performance and unnecessary costs.

Moreover, existing traditional methods tend to adopt a reactive approach to network optimization, addressing issues only when they become apparent or when customer complaints arise. This reactive approach can lead to prolonged service disruptions and lower customer satisfaction. Operators need a more proactive approach that enables them to identify and resolve network problems before they impact customers.

Furthermore, traditional methods may lack seamless integration with planning tools, limiting their ability to leverage accurate data for network analysis. This integration gap can hinder effective decision-making and impede network optimization efforts. Operators require a more integrated approach that leverages planning tools to enhance the accuracy and efficiency of network analysis.

There is, therefore, a need in the art to provide a system and a method that can mitigate the problems associated with the prior arts.

### OBJECTS OF THE INVENTION

It is an object of the present disclosure to provide a system and a method that utilizes precise latitude and longitude coordinates to perform network analysis, providing accurate insights into the performance of a specific location to enables operators to identify and address area-specific issues more effectively.

It is an object of the present disclosure to provide a system and a method that allows operators to proactively identify potential issues before they escalate and helps prevent customer dissatisfaction and improves overall network performance.

It is an object of the present disclosure to provide a system and a method that identifies area-specific network issues, such as barring, coverage, outage, congestion, and interference, enabling operators to optimize the network in those areas, and by resolving these issues, operators can enhance customer satisfaction and improve network performance.

It is an object of the present disclosure to provide a system and a method that provides valuable information to customer care agents when customers call for support, agents access network analysis results for a specific location, allowing them to provide accurate and informed assistance to customers regarding network issues and their corresponding resolutions.

It is an object of the present disclosure to provide a system and a method that plot best serving plot(s) at the analysed location to ensure that analysis is based on reliable data and enhances the efficiency of using planning tools for network optimization.

It is an object of the present disclosure to provide a system and a method that covers various aspects of network performance, including barring, coverage, outage, congestion, and interference, and considering multiple aspects, operators gain a comprehensive understanding of the network's strengths and weaknesses, facilitating targeted improvements.

It is an object of the present disclosure to provide a system and a method that contributes to improved customer satisfaction, and providing a reliable and optimized network experience enhances customer loyalty and positively impacts the operator's reputation.

It is an object of the present disclosure to provide a system and a method that analyse network performance at various locations, whether it is a single location or multiple locations, the system provides consistent and reliable analysis, facilitating network improvements across different geographical areas.

### SUMMARY

The present disclosure discloses a system for analysing performance of a network in real time. The system includes a receiving unit, a plotting unit, a processing unit, and an analysing unit. The receiving unit is configured to receive a location of a user equipment using a location application programming interface (API). The plotting unit is configured to cooperate with the receiving unit to receive the location and configured to retrieve latitude and longitude coordinates corresponding to the received location. The plotting unit is configured to plot the retrieved coordinates on a map. The processing unit is configured to cooperate with the plotting unit and considers a buffered region up to a predefined distance surrounding the plotted coordinates on the map. The processing unit is configured to receive information from at least one source corresponding to the buffered region in real time. The processing unit is configured to determine a plurality of best serving plots (BSPs) located within the buffered region from based on the received information. The analysing unit is configured to cooperate with the processing unit and is configured to analyse a plurality of performance attributes associated with each of the determined BSPs for determining at least one network issue associated with the network. The plotting unit, the processing unit, and the analysing unit are implemented using one or more processor(s).

In an embodiment, the information includes active barred site details, reference signal received power (RSRP), reference signal received quality (RSRQ), and signal-to-interference-plus-noise ratio (SINR).

In an embodiment, the predefined distance is 100 meter.

In an embodiment, the plurality of BSPs includes a network cell, or a base station.

In an embodiment, the plurality of performance attributes includes barring, coverage, outage, congestion, and interference.

In an embodiment, the system is further configured to determine at least one operative state of the network based on the analyzed plurality of performance attributes each of the determined BSPs.

In an embodiment, the at least one determined operative state is a congested state, a coverage state, a barred state, an outage state, and an interference state.

In an embodiment, the system further includes a memory configured to store a plurality of predefined cell identities (IDs) and a plurality of cell location corresponding to a plurality of network cells.

In an embodiment, the system is configured to store the at least one determined operative state and the plurality of analyzed performance attributes in the memory along with a time stamp.

In an embodiment, the system is further configured to determine an extent of the at least one determined operative state and provide at least one resolution corresponding to the at least one determined operative state based on the determined extent.

For determining the barred state, the analysing unit is configured to retrieve a cell ID corresponding to each of the determined BSPs with a list having cell IDs corresponding to barred network cells in the network.

For determining the coverage state, the analysing unit is configured to map reference signal received power (RSRP) corresponding to each of the determined BSPs with a RSRP range stored in the at least one source.

For determining the outage state, the analysing unit is configured to map the retrieved cell ID corresponding to each of the determined BSPs with a list having cell IDs having active outage in the network stored in the memory.

For determining the congested state, the analysing unit is configured to map the retrieved cell ID corresponding to each of the determined BSPs with a list having cell IDs corresponding to congested network cells in the network stored in the memory.

For determining the interference state, the analysing unit is configured to map the retrieved cell ID corresponding to each of the determined BSPs with a list having cell IDs having interference stored in the memory.

In an embodiment, the system is configured to provide the at least one resolution by considering at least one or more of the at least one operative state, historical data representing reoccurrence of the at least one determined operative state, and current network conditions.

In an embodiment, the at least one source is one of an operational support system (OSS), a unified data repository (UDR), and a plurality of network functions.

In an embodiment, the system includes a display unit configured to display the at least one determined operative state of the network cell and the suggested at least one resolution.

The present disclosure discloses a method of analysing performance of a network in real time. The method includes receiving a location of a user equipment using a location application programming interface (API). The method includes retrieving latitude and longitude coordinates corresponding to the received location. The method includes plotting the retrieved coordinates on a map. The method includes considering a buffered region up to a predefined distance surrounding the plotted coordinates on the map. The method includes receiving information from at least one source corresponding to the buffered region in real time. The method includes determining a plurality of best serving plots (BSPs) located within the buffered region based on the received information, wherein the plurality of BSPs is a network cell, or a base station. The method includes analysing a plurality of performance attributes associated with each of the determined BSPs for determining at least one network issue associated with the network.

In an aspect, the method further comprising a step of determining at least one operative state of the network based on the analyzed plurality of performance attributes each of the determined BSPs.

In an aspect, the method further comprising a step of storing the at least one determined operative state and the plurality of analyzed performance attributes in the memory along with a time stamp.

In an aspect, the method further comprising a step of determining an extent of the determined operative state and provides at least one resolution based on the determined extent.

In an aspect, the method further comprising a step of providing the at least one resolution by considering at least one or more of the at least one operative state, historical data representing reoccurrence of the at least one determined operative state, and current network conditions.

In an aspect, the method further comprising a step of displaying the at least one determined operative state of the network cell and the suggested at least one resolution.

In an exemplary embodiment, the present disclosure discloses a user equipment which is configured to analyse performance of a network in real time. The user equipment includes a processor, and a computer readable storage medium storing programming instructions for execution by the processor. Under the programming instructions, the processor is configured to receive a location of a user equipment using a location application programming interface (API). Under the programming instructions, the processor is configured to retrieve latitude and longitude coordinates corresponding to the received location. Under the programming instructions, the processor is configured to plot the retrieved coordinates on a map. Under the programming instructions, the processor is configured to consider a buffered region up to a predefined distance surrounding the plotted coordinates. Under the programming instructions, the processor is configured to receive information from at least one source corresponding to the buffered region in real time. Under the programming instructions, the processor is configured to plot the received information corresponding to the buffered region on the map. Under the programming instructions, the processor is configured to determine a plurality of best serving plots (BSPs) located within the buffered region based on the plotted information. Under the programming instructions, the processor is configured to analyze a plurality of performance attributes associated with each of the determined BSPs for determining at least one network issue associated with the network.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for analysing performance of a network in real time, in accordance with an embodiment of the present disclosure.

FIG. 2 illustrates a block diagram of the system, in accordance with an embodiment of the present disclosure.

FIG. 3 illustrates exemplary steps of a method of analysing network performance of a location, in accordance with an embodiment of the present disclosure.

FIG. 4 illustrates an example representation of various determined best serving plots (BSPs) corresponding to the location of the user and analysed network performance, in accordance with an embodiment of the present disclosure.

FIG. 5 illustrates a flow chart showing steps of a method of analysing network performance of a location, in accordance with an embodiment of the present disclosure.

FIG. 6 illustrates an example computer system in which or with which the embodiments of the present disclosure may be implemented.

The foregoing shall be more apparent from the following more detailed description of the disclosure.

### LIST OF REFERENCE NUMERALS

100—Network Architecture
102-1, 102-2 . . . 102-N—Operators
104-1, 104-2 . . . 104-N—Computing devices
106—Network
108—System
202—Receiving Unit
204—Memory
206—Interface(s)
208—Plotting Unit
210—Processing Unit
212—Analysing Unit
610—External Storage Device
620—Bus
630—Main Memory
640—Read Only Memory
650—Mass Storage Device
660—Communication Port
670—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The present disclosure provides a network analysis of any location, enabling a better understanding of the network performance in that specific area. The present disclosure helps operators to identify and optimize area-specific issues. The present disclosure may be employable in customer care support. From the customer care perspective, this information is handy to care agents when a customer calls in. The present disclosure allows the customer care representative or an operator to provide accurate information to the customer regarding the issues they are experiencing and the corresponding resolution.

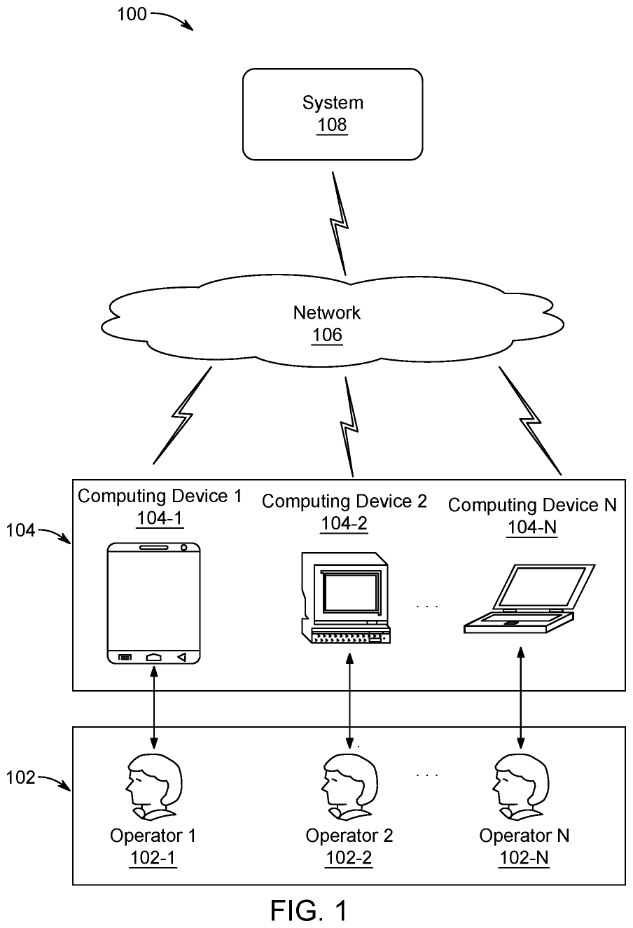

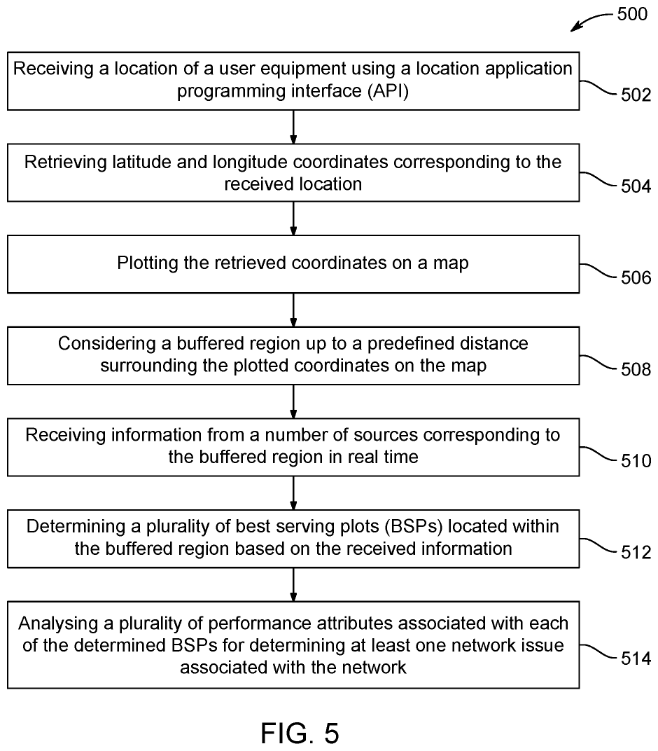

The various embodiments throughout the disclosure will be explained in more detail with reference to FIG. 1-FIG. 6.

FIG. 1 illustrates an exemplary network architecture (100) of a system (108) for analysing performance of a network in real time, in accordance with an embodiment of the present disclosure.

As illustrated in FIG. 1, one or more computing devices (104-1, 104-2 . . . 104-N) may be connected to the system (108) through a network (106). A person of ordinary skill in the art will understand that the one or more computing devices (104-1, 104-2 . . . 104-N) may be collectively referred as computing devices (104) and individually referred as a computing device (104). One or more operators (102-1, 102-2 . . . 102-N) may provide one or more requests to the system (108). A person of ordinary skill in the art will understand that the one or more operators (102-1, 102-2 . . . 102-N) may be collectively referred as operators or customer care representatives (102) and individually referred as an operators (102).

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the operator (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth.

The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an operative aspect, the system (108) is configured to receive a location of a user equipment (as an input) from the one or more computing devices (104) associated with the one or more operators (102). In an embodiment, the system may be configured to automatically retrieve the location of the user equipment. In an aspect, the input includes latitude and longitude coordinates associated with the user equipment. The latitude and longitude coordinates of the location are received by the system (108) using a location application programming interface (API).

In an embodiment, the system (108) is configured to plot the received latitude and longitude coordinates on a map. In an aspect, the system (108) provides a visual reference of the specific location being analysed. This allows operators (102) to have a clear and intuitive understanding of the geographical context (geographical area) in which network performance is being assessed. The plotted coordinates on the map help the network operator in visually identifying the exact location of the user's device and the surrounding area. This visualization can assist in identifying any patterns or trends related to network performance based on geographical proximity. By incorporating map visualization, the system (108) enhances the analysis process by providing a spatial representation of the network performance and its relation to specific locations. It enables operators to gain a better understanding of network behaviour across different areas and make informed decisions regarding network optimization and issue resolution.

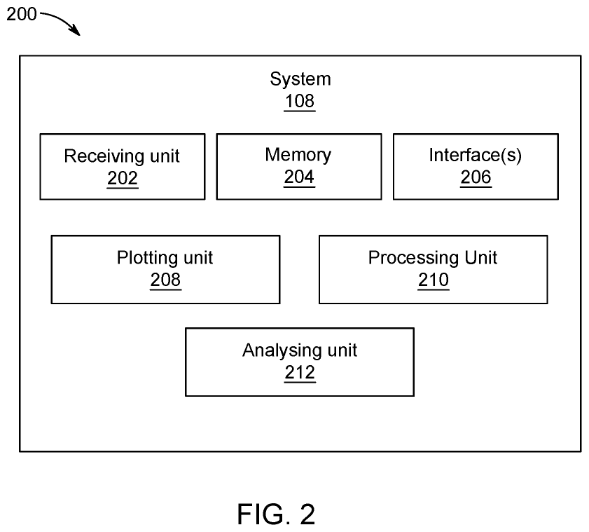

FIG. 2 illustrates an example block diagram (200) of the system (108), in accordance with an embodiment of the present disclosure.

As shown in FIG. 2, the system (108) includes a receiving unit (202), a plotting unit (208), a processing unit (210), and an analysing unit (212). The receiving unit is configured to receive a location of the user equipment using the location application API. In an aspect, the receiving unit (202) is configured to receive the location from the network operator.

The plotting unit (208) is configured to cooperate with the receiving unit (202) to receive the location. The plotting unit (208) is configured to retrieve latitude and longitude coordinates corresponding to the received location. In an example, the latitude and longitude coordinates are retrieved by the plotting unit (208) through the AP). The plotting unit (208) is configured to plot the received coordinates on a map.

The processing unit is configured to cooperate with the plotting unit and considers a buffered region up to a predefined distance surrounding the plotted coordinates on the map. The buffered region is a zone or area created around the plotted location by extending a specific distance in all directions. The size of the buffered region can be predetermined or configurable based on the requirements of the analysis. In an example, the predefined distance is 100 meter.

The buffered region serves multiple purposes in the network analysis process. It helps define the scope within which the system (108) will analyse the network performance and identify potential issues. By considering the network elements within the buffered region, the system (108) focuses on the specific area of interest for analysis. Additionally, the buffered region helps account for any spatial dependencies or network conditions that may influence the performance at the plotted location. It ensures that the analysis takes into consideration the neighbouring network elements and their potential impact on the network performance.

Moreover, by generating the buffered region surrounding the plotted location, the system (108) provides a spatial context for the network analysis. It allows network engineers or operators to assess the network performance within a specific area and gain insights into any area-specific issues that may affect the overall network performance. This information enables them to optimize the network and address performance concerns in a targeted and efficient manner.

The processing unit is configured to receive information from at least one source corresponding to the buffered region in real time. In an example, the information includes active barred site details, reference signal received power (RSRP), reference signal received quality (RSRQ), and signal-to-interference-plus-noise ratio (SINR). In an example, the at least one source is one of an operational support system (OSS), a unified data repository (UDR), and a plurality of network functions. In an aspect, the plotting unit (208) is configured to plot the received information corresponding to the buffered region on the map.

The processing unit is configured to determine a plurality of best serving plots (BSPs) located within the buffered region from based on the received information. For example, the plurality of BSPs includes a network cell, or a base station. In an embodiment, the system (108) is configured to plot the best serving plot(s) (BSPs) using one or more planning tools. In an example, the planning tool is software applications specifically designed for network planning and optimization, to determine the best serving plot(s) for the analysed location. By plotting the best serving plot(s) (also referred as best server(s)) on the map, the system (108) enables operators and users to visualize the network infrastructure and understand which server(s) are associated with the analysed location. This information is valuable for network analysis and optimization efforts, as it helps in evaluating the existing network configuration and determining if any adjustments or improvements are necessary.

In an aspect, the system (108) is configured to generate a list of network cell ids corresponding to the identified BSPs serving at that location. In an operative aspect, the described system (108) has the capability to identify the best-serving plot (BSP) within the generated buffered region. The BSPs refer to the network cells or base stations that are considered to be the best serving or providing optimal coverage within the buffered region. The identification of BSPs within the buffered region is based on network planning and optimization data. The processing unit (210) is configured to determine which network cells or base stations are expected to offer the best network performance in the analysed area. These BSPs are specifically selected as they are deemed to have the highest quality of service within the buffer zone.

Moreover, by identifying the BSPs within the buffered region, the system (108) focuses on the network elements that are directly relevant to the analysed location. It narrows down the scope of analysis to the specific network cells or base stations that have the potential to impact the network performance in that area. This identification of BSPs within the buffered region helps operators to gain a more targeted understanding of the network infrastructure and performance in the vicinity of the analysed location. It allows for a focused analysis and optimization efforts on the network elements that have the most influence on the user experience within the buffer zone.

The analysing unit is configured to cooperate with the processing unit and is configured to analyse a plurality of performance attributes associated with each of the determined BSPs for determining at least one network issue associated with the network. In an example, the plurality of performance attributes includes barring, coverage, outage, congestion, and interference. The analysing unit is further configured to determine at least one operative state of the network based on the analyzed plurality of performance attributes each of the determined BSPs. In an example, the at least one determined operative state is a congested state, a coverage state, a barred state, an outage state, and an interference state.

The plotting unit, the processing unit, and the analysing unit are implemented using one or more processor(s).

The system further includes a memory configured to store a plurality of predefined cell identities (IDs) and a plurality of cell location information corresponding to the plurality of network cells. The system is configured to store the at least one determined operative state and the plurality of analyzed performance attributes along with a time stamp in the memory. For determining the barred state, the analysing unit is configured to retrieve a cell ID corresponding to each of the determined BSPs with a list having cell IDs corresponding to barred network cells in the network.

For determining the coverage state, the analysing unit is configured to map reference signal received power (RSRP) corresponding to each of the determined BSPs with a RSRP range stored in the at least one source.

For determining the outage state, the analysing unit is configured to map the retrieved cell ID corresponding to each of the determined BSPs with a list having cell IDs having active outage in the network stored in the memory.

For determining the congested state, the analysing unit is configured to map the retrieved cell ID corresponding to each of the determined BSPs with a list having cell IDs corresponding to congested network cells in the network stored in the memory.

For determining the interference state, the analysing unit is configured to map the retrieved cell ID corresponding to each of the determined BSPs with a list having cell IDs having interference stored in the memory.

The system is further configured to determine an extent of the at least one determined operative state and provide at least one resolution corresponding to the at least one determined operative state based on the determined extent. By conducting this analysis, the system (108) provides valuable insights into the network performance and identifies specific issues affecting the identified BSPs within the buffer zone. This information allows operators to take targeted actions to address the identified issues, leading to improved network performance and enhanced customer satisfaction in the analysed area.

In an embodiment, the system is configured to provide the at least one resolution by considering at least one or more of the at least one operative state, historical data representing reoccurrence of the at least one determined operative state, and current network conditions.

In an embodiment, the system includes a display unit configured to display the at least one determined operative state of the network cell and the suggested at least one resolution.

The analysing unit is configured to analyse the identified BSPs for determining at least one network issue associated with the network. In an example, the at least one network issue is selected from a group having of barring, coverage, outage, congestion, and interference. When the BSPs within the buffer zone are identified, the system (108) proceeds to conduct a comprehensive analysis of these network elements. This analysis aims to identify any potential issues that may be affecting the network performance in the analysed area. The system (108) examines each identified BSP individually and assesses it for different types of network issues. These issues include:
(a) Barring: The system (108) checks if any of the identified BSPs are subject to network barring, which refers to restrictions or limitations imposed on certain network services or access. It identifies whether there are any active barring settings associated with the BSPs.
(b) Coverage: The system (108) evaluates the coverage provided by the identified BSPs. It compares the actual network coverage at the location with the expected coverage based on planning tools and algorithms. This analysis helps determine if the BSPs offer excellent, good, poor, and bad in the analysed area.
(c) Outage: The system (108) investigates if there are any active network outages associated with the identified BSPs. It checks for outage alarms or notifications indicating service disruptions in the area. This analysis helps identify whether there is a full or partial network outage affecting the BSPs within the buffer zone.
(d) Congestion: The system (108) examines if there is any network congestion present in the identified BSPs. It refers to situations where network resources are overloaded or strained, leading to degraded performance. The system (108) looks for consistent reports of highly congested cells within the buffer zone to determine if there is full or partial congestion affecting the BSPs.
(e) Interference: The system (108) checks for active interference alarms associated with the identified BSPs. Interference refers to the presence of unwanted signals that can degrade network performance. By analysing interference alarms, the system (108) determines if there is full or partial interference affecting the BSPs in the analysed area.

In an embodiment, the system (108) determines extent of the identified network issues and provide a network performance verdict After analysing the identified best serving plots (BSPs) for various network issues, the system (108) evaluates the severity and impact of these issues on the overall network performance in the analysed area. Based on the analysis results, the system (108) assesses the extent of the identified network issues. It considers factors such as the number of BSPs affected, the severity of the issues, and their impact on network performance. These evaluations help determine the overall network performance level for the analysed area. The system (108) then provides a network performance verdict, which is a categorical assessment of the network performance based on the extent of the identified issues. The network performance verdict can be one of the following:
Excellent: If no significant network issues are identified or if the identified issues have a minimal impact on the overall network performance. This verdict indicates that the network is performing exceptionally well in the analysed area.
Good: If there are some minor network issues present, but they have a limited impact on the overall network performance. The network is still providing satisfactory performance in the analysed area.
Poor: If there are noticeable network issues affecting a significant portion of the identified BSPs within the buffer zone. The network performance is below the desired level and may require attention and optimization efforts to improve it.
Bad: If there are severe network issues affecting most or all of the identified BSPs within the buffer zone. The network performance is significantly degraded, leading to a poor user experience and customer dissatisfaction.

Moreover, by providing a network performance verdict, the system (108) offers a clear assessment of the network performance in the analysed area. This verdict helps operators understand the overall network status and prioritize their actions to address the identified issues accordingly. It enables them to focus on areas that require immediate attention and allocate resources effectively for network optimization and improvement efforts.

In an embodiment, the system (108) is configured to suggest at least one resolution corresponding to the determined at least one network issue. In an embodiment, the system (108) is configured to output the network performance verdict and resolutions, along with an estimated time of arrival (ETA) for resolution implementation, enabling network engineers or operators to adjust improve network performance on the received location. By outputting the network performance verdict, resolutions, and ETA, the system (108) enables network engineers or operators to take proactive measures to improve network performance in the received location. They can utilize the provided information to adjust, implement the recommended resolutions, and allocate resources effectively to address the identified issues. This facilitates timely and efficient improvements to the network, leading to enhanced performance, increased customer satisfaction, and a better overall network experience in the analysed area.

In an embodiment, the system (108) is configured to generate real-time network monitoring by integrating network performance data with geographic information. In an aspect, the system (108) is configured to display the suggested at least one resolution on a display unit. The system (108) is configured to visualize network metrics on maps and facilitates proactive troubleshooting and maintenance by utilizing the real-time network monitoring capabilities. When areas experiencing service disruptions are identified, network engineers or operators can immediately initiate troubleshooting processes to diagnose and resolve the issues. They can leverage the integrated information to understand the specific network conditions, identify potential causes of disruptions, and take appropriate actions to rectify the problems.

The processing unit (210) may be implemented as one or more microprocessors, microcomputers, microcontrollers, digital signal processors, central processing units, logic circuitries, and/or any devices that process data based on operational instructions. Among other capabilities, the processing unit (210) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) further includes an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, a database. The system (108) is configured to store the received information in the database. Further, the processing unit (210) includes a BSP engine, a network analysis engine, and other engine(s) (not shown). In an embodiment, the other engine(s) may include, but not limited to, a data ingestion engine, an input/output engine, and a notification engine.

In an embodiment, the processing unit (210) may be implemented as a combination of hardware and programming (for example, programmable instructions) to implement one or more functionalities of the processing unit (210) (also referred as processing engine(s)). In examples described herein, such combinations of hardware and programming may be implemented in several different ways. For example, the programming for the processing engine(s) (202) may be processor-executable instructions stored on a non-transitory machine-readable storage medium and the hardware for the processing engine(s) (202) may comprise a processing resource (for example, one or more processors), to execute such instructions. In the present examples, the machine-readable storage medium may store instructions that, when executed by the processing resource, implement the processing engine(s) (202). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (202) may be implemented by electronic circuitry.

In an operative aspect, the processing unit (210) receives an input (location) through the receiving unit (202) from the computing device (104). This input includes latitude and longitude coordinates of a specific location. The latitude and longitude coordinates are obtained from a customer care system via a location-based service API call and allowing for accurate and reliable data input for further processing and analysis.

In an embodiment, the plotting unit (208) plots a map based on the latitude and longitude coordinates that were received. This map generation process allows for the visualization of the specific location on a graphical representation. By plotting the map, the system (108) provides a visual reference that enables users to understand the geographical context of the given coordinates. This map can be used as a reference for further analysis, such as identifying nearby network elements, assessing coverage areas, or determining potential issues affecting the network performance in that specific location. Further, the plotting unit (208) ensures accurate and precise mapping of the received latitude and longitude coordinates, enhancing the overall effectiveness of the system (108) in analysing and optimizing network performance based on location. In an example, the plotting unit (208) includes a buffer generation engine for creating a buffered region, surrounding the plotted location on the map. The buffered region serves as a designated area around the location of interest. By defining a specific distance or boundary around the plotted location, the buffered region allows for a targeted analysis of network performance within that vicinity. The buffered region helps capture relevant network elements and their potential impact on the network performance, providing a spatial context for further analysis and optimization. This enables network engineers or operators to focus on the specific area of interest and make informed decisions regarding network improvements and issue resolution.

In an embodiment, the processing unit (210) includes the BSP engine that is configured to identify the BSP(s) located within the generated buffered region. The processing unit (210) provides valuable data and insights into the network infrastructure, allowing the system (108) to determine the optimal server(s) for that specific location. By plotting the best server(s) on the map, the system (108) identifies the BSP(s) that fall within the previously generated buffered region. This step helps in narrowing down the analysis to the specific network cells or elements that are most relevant to the analysed location. By considering the BSP(s) within the buffered region, the system (108) can focus on the network performance and potential issues associated with those specific elements, enabling more effective troubleshooting, optimization, and resolution.

In an embodiment, the processing unit (210) analyses the identified BSPs for network issues, by the network analysis engine. The network issues may include but not limited to barring, coverage, outage, congestion, and interference. The analysis involves examining the performance and characteristics of the network elements represented by the BSPs. Based on this analysis, the system (108) determines the extent and severity of network issues and provides a network performance verdict, categorizing it as excellent, good, poor, and bad, also displays to the computing device of the user or customer. Additionally, the network analysis engine generates resolutions for the identified issues and provides an estimated time of arrival (ETA) for implementing the resolutions. This information empowers network engineers or operators to take necessary actions to address the issues and improve network performance in a timely manner, enhancing overall customer satisfaction and network efficiency.

With all the detailed information available, the customer care agent gains a comprehensive understanding of the network aspects at the specific location. This enables the agent to effectively communicate with the user, conveying the knowledge that the operator is aware of the user's issue and actively working towards its resolution. By providing the user with specific network analysis details, a sense of trust is established, instilling confidence in the operator's ability to address the problem. This improved communication and transparency ultimately lead to increased user or customer satisfaction, as they feel heard, understood, and confident in the operator's efforts to resolve their network-related concerns.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

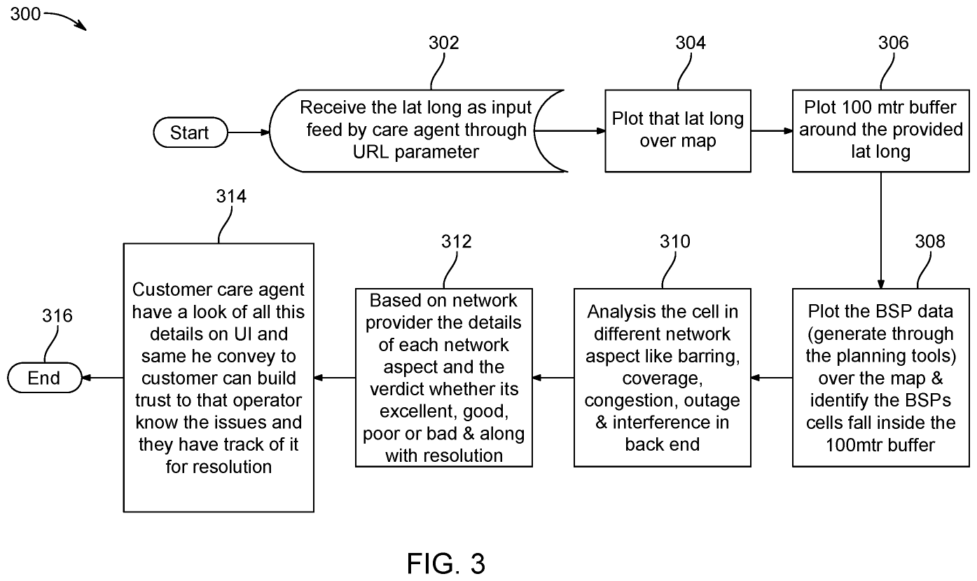

FIG. 3 illustrates an example flow diagram (300) for analysing performance of a network, in accordance with an embodiment of the present disclosure.

As illustrated in FIG. 3, following steps may be implemented by system (108) analysing network performance of the network location wise.

At step 302, the system (108) receives latitude and longitude coordinates of a location feed by a care agent through URL parameters via a location-based service API call.

At step 304, the system (108) plots the received latitude and longitude coordinates on the map.

At step 306, the system (108) generates the buffered region of pre-defined or pre-determined area, for e.g.: 100 meter buffer surrounding the plotted location on the map. The pre-defined area is user defined, or an automated system determined area.

At step 308, the system (108) plots a best serving plot (BSP) at the location based on planning tool and identify BSP(s) located within the generated 100 meter buffer. In an aspect, the BSPs are nothing but list of cell ids serving at that location.

At step 310, the system (108) analyses the identified BSPs for network issues including barring, coverage, outage, congestion, and interference.

At step 312, the system (108) determines the extent of the identified network issues and providing a network performance verdict of excellent, good, poor, and bad, along with its ETA.

At step 314, the system (108) suggests corresponding resolutions for any identified network issues, customer care agent have a look of all details on user interface and convey to customer, so that customer can build trust to that operator to know the issues, and they track of it, which ultimately provide satisfaction to customer.

At step 316, the method (flow diagram (300) is terminated.

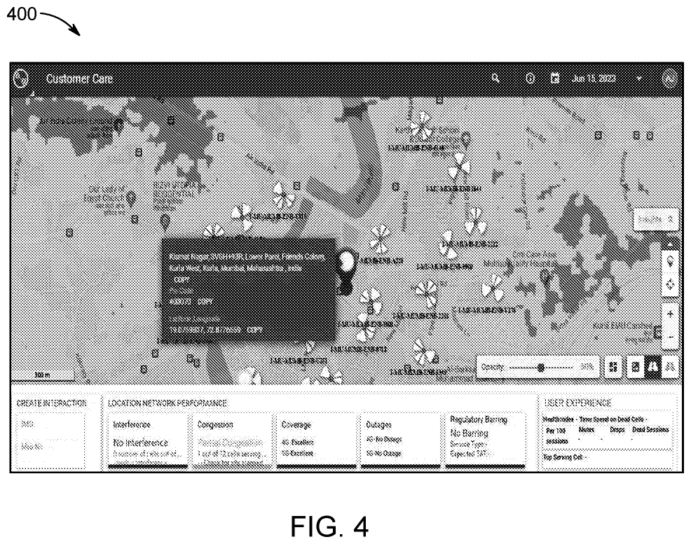

FIG. 4 illustrates an exemplary representation (400) of various determined BSPs corresponding to the location of the user and analysed network performance, in accordance with an embodiment of the present disclosure.

As illustrated in FIG. 4, in an embodiment, system (108) provides a visual representation of the user's location and the analysed network performance. This visualization allows customer care agents, operators, and users to easily access and check the network performance specifically in their respective locations or the locations associated with their devices. By visually depicting the network performance data on a map or other graphical interface, stakeholders can quickly understand the quality and status of the network in their specific areas. This visualization empowers customer care agents to provide accurate and informed assistance to users, enables operators to make data-driven decisions for network optimization, and allows users to have a clear understanding of the network performance in their vicinity.

The present disclosure discloses a method (500) of analysing performance of the network in real time.

At step (502), the method includes receiving a location of a user equipment using a location application programming interface (API). The system (108) is configured to receive the location of the user equipment (as an input) from the one or more computing devices (104). In an embodiment, the system may be configured to automatically retrieve the location of the user equipment. In an aspect, the input includes latitude and longitude coordinates associated with the user equipment.

At step (504), the method includes retrieving latitude and longitude coordinates corresponding to the received location.

At step (506), the method includes plotting the retrieved coordinates on a map.

At step (508), the method includes considering a buffered region up to a predefined distance surrounding the plotted coordinates on the map.

At step (510), the method includes receiving information from at least one source corresponding to the buffered region in real time. In an embodiment, the at least one source is one of an operational support system (OSS), a unified data repository (UDR), and a plurality of network functions.

At step (512), the method includes determining a plurality of best serving plots (BSPs) located within the buffered region based on the received information. The plurality of BSPs is a network cell, or a base station.

At step (514), the method includes analysing a plurality of performance attributes associated with each of the determined BSPs for determining at least one network issue associated with the network. In an example, the plurality of performance attributes includes barring, coverage, outage, congestion, and interference. In an aspect, the at least one determined operative state is a congested state, a coverage state, a barred state, an outage state, and an interference state.

In an aspect, the method further comprising a step of determining at least one operative state of the network based on the analyzed plurality of performance attributes each of the determined BSPs.

In an aspect, the method further comprising a step of storing the at least one determined operative state and the plurality of analyzed performance attributes in the memory along with a time stamp.

In an aspect, the method further comprising a step of determining an extent of the determined operative state and provides at least one resolution based on the determined extent.

In an aspect, the method further comprising a step of providing the at least one resolution by considering at least one or more of the at least one operative state, historical data representing reoccurrence of the at least one determined operative state, and current network conditions.

In an aspect, the method further comprising a step of displaying the at least one determined operative state of the network cell and the suggested at least one resolution.

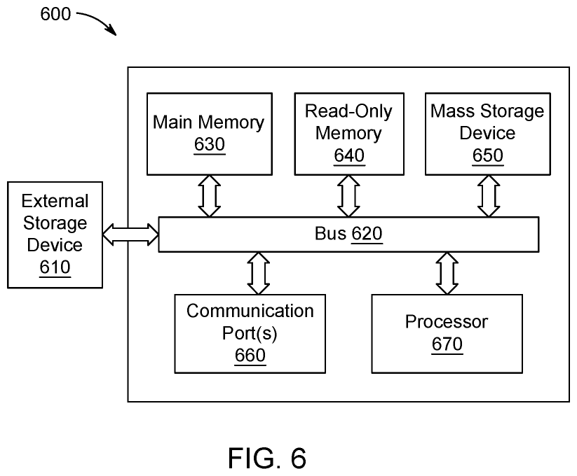

FIG. 6 illustrates an example computer system (600) in which or with which the embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (670) to the computer system (600).

In another embodiment, operator, and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

In an exemplary embodiment, the present disclosure discloses a user equipment which is configured to analyse performance of a network in real time. The user equipment includes a processor, and a computer readable storage medium storing programming instructions for execution by the processor. Under the programming instructions, the processor is configured to receive a location of a user equipment using a location application programming interface (API). Under the programming instructions, the processor is configured to retrieve latitude and longitude coordinates corresponding to the received location. Under the programming instructions, the processor is configured to plot the retrieved coordinates on a map. Under the programming instructions, the processor is configured to consider a buffered region up to a predefined distance surrounding the plotted coordinates. Under the programming instructions, the processor is configured to receive information from at least one source corresponding to the buffered region in real time. Under the programming instructions, the processor is configured to plot the received information corresponding to the buffered region on the map. Under the programming instructions, the processor is configured to determine a plurality of best serving plots (BSPs) located within the buffered region based on the plotted information. Under the programming instructions, the processor is configured to analyze a plurality of performance attributes associated with each of the determined BSPs for determining at least one network issue associated with the network.

The present disclosure is configured to provide system and method for network performance analysis based on location. Basically, it may help to understand what the network performance at that specific location is. The system (108) can be extended to other technologies as well such as Wi-Fi, and various areas where network performance (such as satellite communication, navigational systems) are required. The system (108) provides network analysis to understand any issues and its corresponding resolution such that a network operator is able to convey all this details to a customer so a trust start building to the customer that operator knows the issue and are on track for its resolution.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE INVENTION

The present disclosure aims to provide a system and method that utilize precise latitude and longitude coordinates for network analysis, offering accurate insights into the performance of a specific location. This enables operators to effectively identify and address issues specific to certain areas.

The present disclosure aims to provide a system and method that enable operators to proactively identify potential issues before they escalate, thereby preventing customer dissatisfaction and improving overall network performance.

The present disclosure aims to provide a system and method that identify network issues specific to particular areas, such as barring, coverage, outage, congestion, and interference. This empowers operators to optimize the network in those areas, resulting in enhanced customer satisfaction and improved network performance through issue resolution.

The present disclosure aims to provide a system and method that furnish valuable information to customer care agents when customers seek support, and accessing network analysis results for a specific location, and agents offer accurate assistance to customers regarding network issues and their corresponding resolutions.

The present disclosure aims to provide a system and method that at plot best serving plot(s) at analysed location and ensures that reliable data is used for analysis and enhances the efficiency of utilizing planning tools for network optimization.

The present disclosure aims to provide a system and method that cover various aspects of network performance, including barring, coverage, outage, congestion, and interference, and by considering multiple facets, operators gain a comprehensive understanding of the network's strengths and weaknesses, enabling targeted improvements.

The present disclosure aims to provide a system and method that provides a reliable and optimized network experience, customer loyalty is enhanced, positively impacting the operator's reputation.

The present disclosure aims to provide a system and method that analyse network performance at different locations, regardless of whether it is a single or multiple locations. and ensures consistent and reliable analysis. facilitating network improvements across various geographical areas.

1. A system for analysing performance of a network in real time, the system comprising:
a receiving unit configured to receive a location of a user equipment using a location application programming interface (API);
a plotting unit configured to cooperate with the receiving unit to receive the location and further configured to:
retrieve latitude and longitude coordinates corresponding to the received location;
plot the retrieved coordinates on a map; and
a processing unit configured to cooperate with the plotting unit and configured to:
define a buffered region up to a predefined distance surrounding the plotted coordinates on the map;
receive information from at least one source corresponding to the buffered region in a real-time;
determine a plurality of best serving plots (BSPs) located within the buffered region based on the received information; and
an analysing unit configured to cooperate with the processing unit and is further configured to:
analyse a plurality of performance attributes associated with each of the determined BSPs for determining at least one network issue associated with the network,
wherein the plotting unit, the processing unit , and the analysing unit are implemented using one or more processor(s).

2. (canceled)

3. (canceled)

4. (canceled)

5. The system as claimed in claim 1, wherein the plurality of performance attributes includes barring, coverage, outage, congestion, and interference.

6. The system as claimed in claim 1, is further configured to determine at least one operative state of the network based on the analyzed plurality of performance attributes associated with each of the determined BSPs.

7. The system as claimed in claim 6, wherein the at least one determined operative state is a congested state, a coverage state, a barred state, an outage state, and an interference state.

8. The system as claimed in claim 1, further includes a memory configured to store a plurality of predefined cell identities (IDs) and a plurality of cell location information corresponding to a plurality of network cells.

9. The system as claimed in claim 6, is configured to store the at least one determined operative state and the plurality of analyzed performance attributes in the memory along with a time stamp.

10. The system as claimed in claim 7, wherein for determining the barred state, the analysing unit is configured to retrieve a cell ID corresponding to each of the determined BSPs with a list having cell IDs corresponding to barred network cells in the network.

11. The system as claimed in claim 7, wherein for determining the coverage state, the analysing unit is configured to map reference signal received power (RSRP) corresponding to each of the determined BSPs with an RSRP range stored in the at least one source.

12. The system as claimed in claim 7, wherein for determining the outage state, the analysing unit is configured to map the retrieved cell ID corresponding to each of the determined BSPs with a list having cell IDs having active outage in the network stored in the memory.

13. The system as claimed in claim 7, wherein for determining the congested state, the analysing unit is configured to map the retrieved cell ID corresponding to each of the determined BSPs with a list having cell IDs corresponding to congested network cells in the network stored in the memory.

14. The system as claimed in claim 7, wherein for determining the interference state, the analysing unit is configured to map the retrieved cell ID corresponding to each of the determined BSPs with a list having cell IDs having interference stored in the memory.

15. The system as claimed in claim 6, wherein the analysing unit is further configured to determine an extent of the determined operative state and provides at least one resolution based on the determined extent.

16. The system as claimed in claim 6, wherein the analysing unit is configured to provide the at least one resolution by considering at least one or more of the at least one determined operative state, historical data representing reoccurrence of the at least one determined operative state, and current network conditions.

17. (canceled)

18. (canceled)

19. A method of analysing performance of a network in real time, the method comprising:
receiving a location of a user equipment using a location application programming interface (API);
retrieving latitude and longitude coordinates corresponding to the received location;
plotting the retrieved coordinates on a map;
considering a buffered region up to a predefined distance surrounding the plotted coordinates on the map;
receiving information from at least one source corresponding to the buffered region in real time;
determining a plurality of best serving plots (BSPs) located within the buffered region based on the received information, wherein the plurality of BSPs is a network cell, or a base station; and
analysing a plurality of performance attributes associated with each of the determined BSPs for determining at least one network issue associated with the network.

20. (canceled)

21. (canceled)

22. The method as claimed in claim 19, wherein the plurality of performance attributes includes barring, coverage, outage, congestion, and interference.

23. The method as claimed in claim 19, further comprising determining at least one operative state of the network based on the analyzed plurality of performance attributes associated with each of the determined BSPs.

24. (canceled)

25. The method as claimed in claim 23, wherein the at least one determined operative state is a congested state, a coverage state, a barred state, an outage state, and an interference state.

26. The method as claimed in claim 23, further comprising determining an extent of the determined operative state and provides at least one resolution based on the determined extent.

27. The method as claimed in claim 23, further comprising providing the at least one resolution by considering at least one or more of the at least one operative state, historical data representing reoccurrence of the at least one determined operative state, and current network conditions.

28. (canceled)

29. A computer program product comprising a non-transitory computer-readable medium comprising instructions that, when executed by one or more processors, cause the one or more processors to:
receive a location of a user equipment using a location application programming interface (API);
retrieve latitude and longitude coordinates corresponding to the received location;
plot the retrieved coordinates on a map;
consider a buffered region up to a predefined distance surrounding the plotted coordinates;
receive information from at least one source corresponding to the buffered region in real time;
plot the received information corresponding to the buffered region on the map;
determine a plurality of best serving plots (BSPs) located within the buffered region based on the plotted information; and
analyze a plurality of performance attributes associated with each of the determined BSPs for determining at least one network issue associated with a network.

30. (canceled)
